(19) United States
(12) Patent Application Publication
(10) Pub. No.: US 2025/0271464 A1
(43) Pub. Date: Aug. 28, 2025

(54) TRIGGER MECHANISM USING INERTIAL SENSORS

(71) Applicant: Analog Devices, Inc., Wilmington, MA (US)

(72) Inventors: Mahdi M. Sadeghi, Natick, MA (US); Pablo Guillermo del Corro, Wilmington, MA (US)

(21) Appl. No.: 19/066,681

(22) Filed: Feb. 28, 2025

Related U.S. Application Data
(60) Provisional application No. 63/559,117, filed on Feb. 28, 2024.

(51) Int. Cl. G01P 15/18; B25F 5/02; G01P 15/02

(52) U.S. Cl. CPC G01P 15/18; B25F 5/02; G01P 15/02

(57) ABSTRACT

An apparatus for providing variable end user control of a handheld tool function includes a trigger member arranged for travel during user depression relative to a tool body. A first inertial sensor, affixed to either the trigger member or body, maintains a fixed orientation and provides motion data along at least first and second axes. A second inertial sensor, arranged on the trigger member or body, rotates relative to the first inertial sensor during trigger depression, with the rotation amount varying based on depression amount. Throughout its entire range of rotation, the second inertial sensor rotates about a third axis that remains askew with respect to both the first and second axes of the first inertial sensor.

### CLAIM OF PRIORITY

This application claims priority to U.S. provisional Application Ser. No. 63/559,117, filed on Feb. 28, 2024, which is incorporated by reference herein in its entirety, and the benefit of priority of which is claimed herein.

### BACKGROUND

Handheld tools, e.g., power tools, medical devices, etc., can include or use a trigger mechanism to provide end user control of a function (e.g., rotation speed, oscillation, clamping, shearing, etc.) of the tool. Certain trigger mechanisms can provide the end user a nonbinary or varying degree of control of the function.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 depicts various states of depression of an example of a trigger member.

FIG. 2A is a chart showing accelerometer data over time from the first and second inertial sensor when the trigger member is not in a depressed state.

FIG. 2B is a chart showing accelerometer data over time from the first and second inertial sensor when the trigger member is moved toward a depressed state.

FIG. 3A is a three dimensional (3D) graph showing spatial data from the accelerometer when the trigger member is not in a depressed state.

FIG. 3B is a three dimensional (3D) graph showing spatial data from the accelerometer when the trigger member is in a partially depressed state.

FIG. 3C is a three dimensional (3D) graph showing spatial data from the accelerometer when the trigger member is moved toward a fully depressed state.

FIG. 4A depicts an example of a motion conversion mechanism.

FIG. 4B depicts an example of a motion conversion mechanism.

FIG. 5 is a flowchart showing a process for method for providing variable end user control of a handheld tool function.

### DETAILED DESCRIPTION

Certain handheld tools can provide the end user with a varying degree of control of a handheld tool function via a potentiometer. Such a “gradual trigger”, such as in that the trigger is push is proportional to the travel length of the potentiometer, can be used to provide a varying trigger signal that is proportional to the travel length of the trigger button. One challenge with such an approach to providing this varying degree of control is that potentiometers have a limited lifetime, if used repeatedly. For example, certain potentiometers can rely on electrical contacts, which can physically wear out following extensive use. Certain other “contactless” trigger mechanisms can involve the challenge of not providing the end user with a useful range of control, or no range at all (e.g., providing, essentially, a binary “on-or-off” control with little to range where the user can vary a degree of trigger depression and result in a desired range of varying speed or intensity of tool function).

The present inventors have recognized the benefits of systems and methods for providing variable end user (“user”) control of handheld tool functions through innovative sensor configurations and motion detection mechanisms, such as capable of capturing nuanced user inputs and may not provide sufficient granularity for precise tool operation. This document describes a dual-sensor apparatus that enables enhanced control capabilities through differential motion detection. The apparatus can include a wear-resistant contactless trigger member that is arranged for travel during user depression relative to a tool body, and to provide a variable control signal in response to a varying degree of user-depression of the trigger member. In an example, a first inertial sensor is affixed to either the trigger member or the tool body in a fixed orientation, providing motion data along at least first and second axes. The first sensor maintains its orientation relative to both the body and trigger member throughout the trigger's travel such as during user depression of the trigger member. A second inertial sensor can be positioned on one of the trigger member or tool body, such that it rotates relative to the first inertial sensor during trigger depression. The amount of rotation varies in response to the degree of trigger depression. For example, to facilitate the conversion of linear trigger depression into sensor rotation, the system employs a linear-to-rotation motion mechanism. This mechanism may be implemented using various mechanical configurations, including slider cranks, Arandela mechanisms, rack-and-pinion systems, flywheels, steppers, or pawl and escapement arrangements.

In an example, throughout an entire range of rotation of the second inertial sensor, the second inertial sensor rotates about a third axis that remains askew relative to both the first and second axes of the first inertial sensor. For example, the first and second axes of the first inertial sensor are orthogonal to each other, defining a first plane. Similarly, the second inertial sensor provides motion data along fourth and fifth axes that are orthogonal to each other, defining a second plane. The apparatus can be arranged such as to maintain these planes in a unique geometric relationship where, throughout the entire range of rotation of the second inertial sensor, the second plane remains skewed or askew, e.g., neither parallel nor perpendicular to the first plane. The apparatus can include or be communicatively coupled with signal-processing circuitry, e.g., coupled to both inertial sensors, to determine differential measurements of three-dimensional accelerometer output vectors or changes thereof. This can facilitate precise tracking of relative motion between the sensors during trigger actuation.

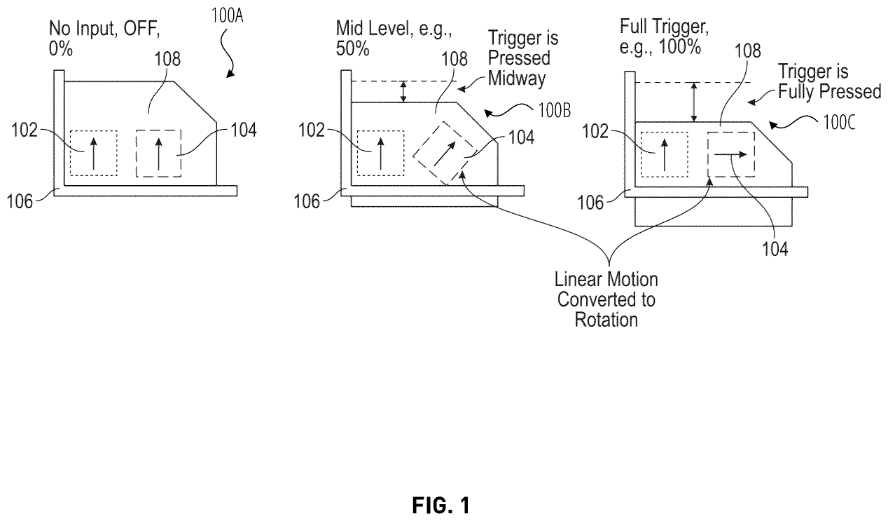

FIG. 1 depicts various states of depression of an example of a trigger member. In an example, an apparatus 100 for a handheld tool control system can include a trigger member 108, which can be capable of depression relative to a tool body (such as a frame or housing 106). The apparatus can include a first inertial sensor 102 and a second inertial sensor 104. The first inertial sensor 102 can be fixed to at least one of the trigger member 108 or the housing 106 and can provide motion data on at least two axes. For example, the first inertial sensor 102 can include an accelerometer, gyroscope, inertial measurement unit (IMU), or a combination thereof capable of providing motion data (e.g., acceleration) of three axes, such as X, Y and Z axes. The second inertial sensor 104 can be arranged within the apparatus 100A such that it rotates relative to the first inertial sensor 102 during user-depression of the trigger member 108.

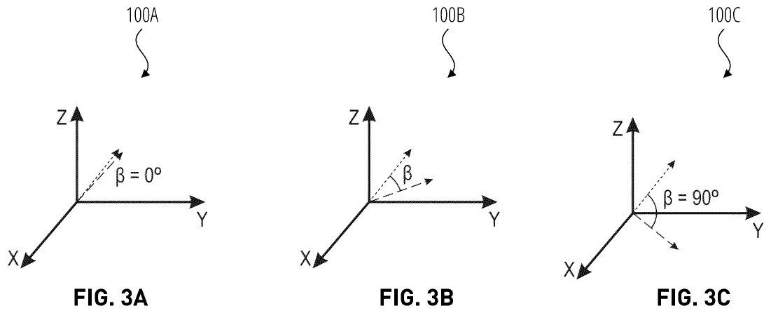

In an example, an amount of rotation of the second inertial sensor 104 can vary based on (e.g., corresponding linearly, logarithmically, antilogarithmically, etc.) to a degree of user-depression of the trigger member 108. As explained further with respect to FIG. 3A, FIG. 3B, and FIG. 3C, the second inertial sensor 104 can rotates about an axis that remains askew to all measurement axes of the first inertial sensor 102, such as throughout an entire range of rotational motion of the second inertial sensor 104. The system can include or be communicatively coupled with signal processing circuitry for determining differential measurements between the sensors.

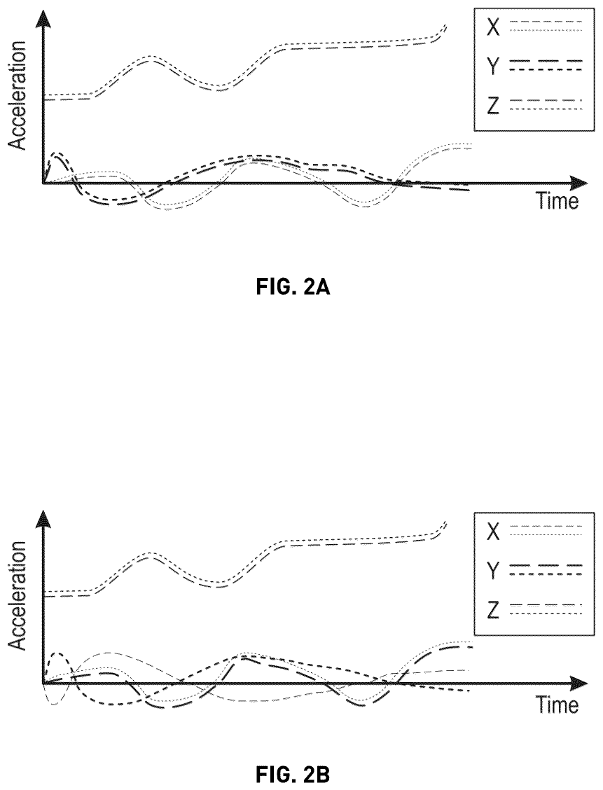

FIG. 2A is a chart showing accelerometer data over time from the first and second inertial sensor when the trigger member is not in a depressed state. In an example, in accordance with orientation 100A of the apparatus 100 as shown in FIG. 1, while the trigger member 108 is at an “off” position, the first inertial sensor 102 and the second inertial sensor 104 can exhibit a similar rotational orientation. If the trigger member is depressed at 50% (e.g., according to orientation 100B of the apparatus 100 in FIG. 1) the second inertial sensor 104 can be rotated approximately at a first angle with respect to the first inertial sensor 102 (e.g., at about 45 degrees as shown in orientation 100B).

FIG. 2B is a chart showing accelerometer data over time from the first and second inertial sensor when the trigger member is moved toward a depressed state. If the trigger member 108 is fully pressed “on” at 100%, the second inertial sensor 104 can be rotated approximately at can be at a second angle, greater than the first angle, with respect to the first inertial sensor 102 (e.g., about 90 degrees with respect to each other, as according to orientation 100C of the apparatus 100 in FIG. 1). By measuring the differential 3D vector of acceleration, e.g., an angle between the acceleration vector from each of the two accelerometers, the trigger member 108 an indication of depression percentage can be determined (e.g., via a look-up table, equation, calibration, etc.), such as including determining certain fully “off” and fully “on” positions of the trigger member 108. With the angle output being a differential measurement, common-mode background vibration or noise can be mitigated or limited.

FIG. 3A, FIG. 3B, and FIG. 3C are each three dimensional (3D) graphs showing spatial data from the accelerometer across various state of trigger member depression. FIG. 3A, FIG. 3B, and FIG. 3C each depict angles β, each indication a spatial domain output of the first inertial sensor 102 and the second inertial sensor 104 respect to each other, each corresponding with an orientation 100A, 100B or 100C of the apparatus 100 as shown in FIG. 1.

In an unskewed approach to determining the indication of trigger member 108 depression percentage, where both the first inertial sensor 102 and the second inertial sensor 104 arranged to calculate their respective acceleration vectors in the same plane (e.g., where the second inertial sensor 104 rotates along an axis perpendicular and orthogonal to the first axis and second axis of measurement of the first inertial sensor 102), a singularity can be observed. For example, a gravity vector can be moved toward an orthogonal orientation with respect to the same plane, and an output of each of the first inertial sensor 102 and the second inertial sensor 104 can be similar or nearly identical despite user-depression of the trigger member 108.

In an example, to mitigate the challenges of the above approach involving such a singularity, the rotary mechanism of the second inertial sensor 104 (e.g., an axis of rotation of the second inertial sensor 104) can be arranged within the apparatus to maintain the rotating second accelerometer skewed or askew, e.g., in a different plane than a first detection plane of the fixed, first inertial sensor 102 (e.g., The first detection plane defined by first and second orthogonal axis or vectors along which the first inertial sensor 102 is tracking motion data).

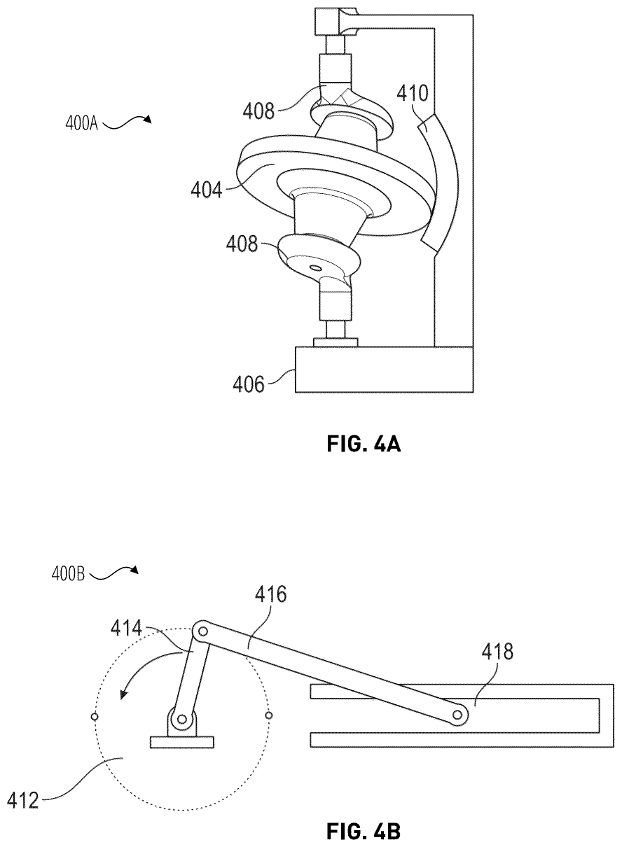

For example, the second inertial sensor 104 can be arranged to provide motion data on at least a fourth axis and a fifth axis, and the fourth axis and the fifth axis can be orthogonal to each other can defining a second detection plane. Here, throughout an entire range of rotation of the second inertial sensor 104, the second detection plane can remain neither parallel nor perpendicular to the first plane (e.g., skewed or askew). Such a configuration can facilitate that there is not a single plane that the projection of gravity on that plane causes both accelerometers to have a fixed differential angular output. As explained further with respect to FIG. 4A and FIG. 4B, such a fixed or variable offset of detection planes of the first inertial sensor 102 and the second inertial sensor 104, maintained throughout an entire range of rotational motion of the second inertial sensor 104, can be facilitated by certain linear-to-rotation motion mechanisms described herein.

FIG. 4A and FIG. 4B each depict an example of a motion conversion mechanism. In an example, the apparatus 100 of FIG. 1 can include one or more motion conversion mechanisms 400, arranged to provide conversion of linear motion from the trigger member 108 (as depicted in FIG. 1) to rotary motion of the second inertial sensor 104 (e.g., along the third axis). Such a linear-to rotation motion conversion can use any of a number of different “rotary mechanisms,” such as a slider crank, an Arandela mechanism, a rack and-pinion, a flywheel, a stepper, a pawl and escapement, a spring-biased or otherwise biased hinged disk or other stage, among others.

As shown in FIG. 4A, the motion conversion mechanism 400A can be configured to convert in-plane rotation into out of-plane motion, such as vertical angular swing, with the depicted ‘Arandela Mechanism’. Here, the linear-to-rotation motion mechanism 400A can include or use a disc 404 arranged to contact an arced member 410, and the arced member 410 can be fixed to a frame 406. Here, the disc 404 can act in a cam-and-follower relationship with the arced member 410, such that an arc of the disc 404 follows an arc of the arced member 410. The disc can pivot about one or more eccentric pivots 408, one or more eccentric pivots 408 can be mounted on the frame 406. As shown in FIG. 4B, the motion conversion mechanism 400B can convert rotational motion (e.g., from a rotary member 412) into linear motion (e.g., motion of a first end of an elongate arm 416 along a channel 418. Here, rotary motion of the rotary member 412 can be converted by the linkage 414 affixed at a second end to the elongate arm 416 to move the first end of the elongate arm in a linear motion. In an example, one can combine slider-crank as depicted with the motion conversion mechanism 400B with an Arandela, as depicted with the motion conversion mechanism 400A, to convert an in-plane linear motion, to an out of plane angular swing.

In an example, the motion conversion mechanism 400 can include a rotating disk (e.g., of the slider crank, the hinged disk, or another rotating component, with a first side that is perpendicular to the axis of rotation, which can serve as a base, and a second side that is at a non-perpendicular angle (e.g., 45 degrees), on which the second accelerometer can be mounted. The range of rotation can be restricted or limited by one or more “stops” such that the first inertial sensor 102 and the second inertial sensor 104 (as depicted in FIG. 1) are maintained such that their respective motion vectors remain non perpendicular nor orthogonal to each other, throughout an entire range of rotation of the second inertial sensor 104.

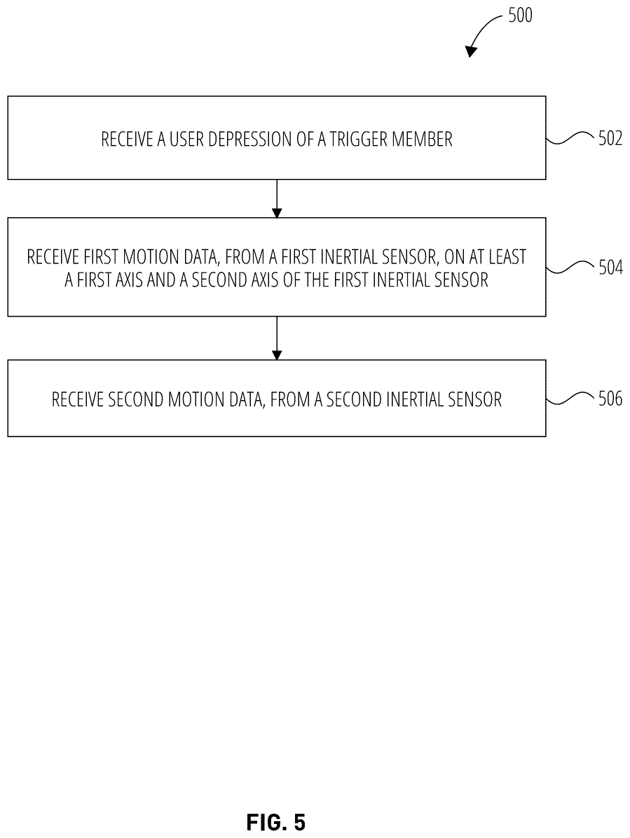

FIG. 5 is a flowchart showing a process for method for providing variable end user control of a handheld tool function.

At 502, the process can involve receiving a user depression input on a trigger member that is configured for travel relative to the tool body. As explained with respect to steps 504 and 506 below, such a user depression can affect a rotational relationship between first and second inertial sensors (e.g., accelerometers) with respect to each other, such that an indication of an amount of trigger depression can be determined (such as without needing a potentiometer or other gradual contact mechanism

At 504, first motion data can be received from a first inertial sensor. Such motion data can be captured along at least a first axis and a second axis, with the first inertial sensor maintaining a fixed orientation relative to both the body and trigger member throughout the depression movement. Here, the first inertial sensor can be affixed at least one of the trigger member or the tool body.

At 506, second motion data can be received from a second inertial sensor. This second sensor can be positioned on either the trigger member or the tool body in such a way that it undergoes rotation relative to the first inertial sensor during trigger depression. Here, an amount of rotation can vary proportionally with a degree of user-depression of the trigger member. In an example, throughout the entire range of motion, the second inertial sensor can rotate about a third axis that maintains an askew orientation relative to both the first and second axes of the first inertial sensor. In an example, a first plane can be defined by the orthogonal first and second axes of the first inertial sensor, and a second plane can be defined by orthogonal fourth and fifth axes of the second inertial sensor. Such first and second planes can be arranged such that the second plane remains neither parallel nor perpendicular to the first plane during the entire range of sensor rotation. In an example, the linear depression of the trigger member can be translated into rotational motion of the second inertial sensor through a linear-to-rotation motion mechanism.

In an example, an indication of an amount of trigger depression can be calculated based on the first and second motion data inputs, such as by determining differential measurements between the three-dimensional accelerometer output vectors from both sensors, or by analyzing changes in these vectors over time.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An apparatus for providing variable end user control of a handheld tool function, the apparatus comprising:
a trigger member arranged for travel, during user depression, with respect to a body of the handheld tool;
a first inertial sensor configured to provide motion data on at least a first axis and a second axis, the first inertial sensor affixed to one of the trigger member or the body and arranged to maintain a fixed orientation relative to the body and the trigger member during the depression; and
a second inertial sensor, arranged on one of the trigger member or the body such that, during the depression, the second inertial sensor rotates with respect to the first inertial sensor by an amount that varies in response to the amount of depression of the trigger member;
wherein, throughout an entire range of rotation of the second inertial sensor, the second inertial sensor rotates about a third axis that is askew with respect to each of the first axis and the second axis of the first inertial sensor.

2. The apparatus of claim 1, comprising signal-processing circuitry coupled to each of the first and second inertial sensors to determine a differential measurement of a three-dimensional (3D) accelerometer output vector, or change therein, provided by the first and second inertial sensors.

3. The apparatus of claim 1, comprising a linear-to-rotation motion mechanism that translates a linear depression of the trigger member to a rotation of the second inertial sensor with respect to the first inertial sensor.

4. The apparatus of claim 3, wherein the linear-to-rotation motion mechanism includes at least one of a slider crank, an Arandela mechanism, a rack-and-pinion, a flywheel, a stepper, or a pawl and escapement.

5. The apparatus of claim 1, wherein the first axis and the second axis are orthogonal to each other, defining a first plane.

6. The apparatus of claim 5, wherein:
the second inertial sensor is configured to provide motion data on at least a fourth axis and a fifth axis, the fourth axis and the fifth axis orthogonal to each other and defining a second plane; and
throughout the entire range of rotation of the second inertial sensor, the second plane remains neither parallel nor perpendicular to the first plane.

7. A method for providing variable end user control of a handheld tool function, the method comprising:
receiving a user depression of a trigger member, arranged for travel with respect to a body of the handheld tool;
receiving first motion data, from a first inertial sensor, on at least a first axis and a second axis of the first inertial sensor, wherein the first inertial sensor is affixed to one of the trigger member or the body and arranged to maintain a fixed orientation relative to the body and the trigger member during the depression; and
receiving second motion data, from a second inertial sensor, wherein the second inertial sensor is arranged on at least one of the trigger member or the body such that, during the depression, the second inertial sensor rotates with respect to the first inertial sensor by an amount that varies in response to the amount of depression of the trigger member;
wherein, throughout an entire range of rotation of the second inertial sensor, the second inertial sensor rotates about a third axis that is askew with respect to each of the first axis and the second axis of the first inertial sensor.

8. The method of claim 7, comprising determining a differential measurement of a three-dimensional (3D) accelerometer output vector, or change therein, provided by the first and second inertial sensors.

9. The method of claim 7, comprising translating, via a linear-to-rotation motion mechanism, a linear depression of the trigger member to a rotation of the second inertial sensor with respect to the first inertial sensor.

10. The method of claim 7, wherein:
the first axis and the second axis are orthogonal to each other, defining a first plane;
the second inertial sensor is configured to provide motion data on at least a fourth axis and a fifth axis, the fourth axis and the fifth axis orthogonal to each other and defining a second plane; and
throughout the entire range of rotation of the second inertial sensor, the second plane remains neither parallel nor perpendicular to the first plane.
